(19) United States
(12) Patent Application Publication
(10) Pub. No.: US 2011/0244366 A1
(43) Pub. Date: Oct. 6, 2011

(54) ION CONDUCTOR AND FUEL CELL

(75) Inventors: Masakazu Sawada, Kanagawa (JP); Shinichi Uesaka, Kanagawa (JP); Kengo Makita, Kanagawa (JP); Kanako Ito, Kanagawa (JP)

(73) Assignee: SONY CORPORATION, Tokyo (JP)

(21) Appl. No.: 12/809,452

(22) PCT Filed: Dec. 17, 2008
(86) PCT No.: PCT/JP2008/072959

§ 371 Date: Jun. 18, 2010

(30) Foreign Application Priority Data
Dec. 20, 2007 (JP) 2007-328850

(51) Int. Cl. H01M 8/10; H01G 9/025

(52) U.S. Cl. 429/491; 252/62.2

(57) ABSTRACT

There is provided a fuel cell capable of ensuring high safety, and capable of obtaining favorable characteristics such as power density. As a first fluid containing an electrolyte, an ion conductor in which an organic compound which is solid at a room temperature and which has at least one of a sulfonic acid group and a phosphoinic acid group is dissolved in a solvent flows through an electrolyte path arranged between a fuel electrode and an oxygen electrode. Thereby, it is possible to suppress resistance between the fuel electrode and the oxygen electrode low. Also, in the case where the solvent is evaporated due to an environmental change, since that organic compound remains as solid, a surrounding member is unlikely to be corroded.

### CROSS REFERENCE TO RELATED APPLICATIONS

The present application is a National Stage of International Application No. PCT/JP2008/072959 filed on Dec. 17, 2008 and which claims priority to Japanese Patent Application No. 2007-328850 filed on Dec. 20, 2007, the entire contents of which are being incorporated herein by reference.

### BACKGROUND

The present disclosure relates to a liquid ion conductor, and a fuel cell using the ion conductor.

As indexes indicating characteristics of a cell, there are an energy density and an output density. The energy density is an energy accumulation amount per unit mass of a cell, and the output density is an output amount per unit mass of the cell. Since a lithium ion secondary cell has two characteristics that the relatively-high energy density and the extremely-high output density, and a degree of perfection is high, the lithium ion secondary cell has been widely employed as a power source of mobile devices. However, in recent years, there is a trend in the mobile device that the power consumption is increased with high performance, and further improvement of the energy density and the output density is desired in the lithium ion secondary cell.

As countermeasures thereof, change of an electrode material constituting a cathode and an anode, improvement of an applying method of the electrode material, improvement of a sealing method of the electrode material, and the like are cited, and study to improve the energy density in the lithium ion secondary cell has been conducted. However, the hurdle for the practical use is still high. Also, unless the material currently used for the lithium ion secondary cell is changed, it is difficult to expect dramatic improvement of the energy density.

Thus, in substitution for the lithium ion secondary cell, development of a cell having higher energy density is urgently demanded, and a fuel cell is regarded as promising as one of the candidates.

The fuel cell has the configuration in which an electrolyte is arranged between an anode (fuel electrode) and a cathode (oxygen electrode), and fuel is supplied to the fuel electrode, and air or oxygen is supplied to the oxygen electrode, respectively. As a result, oxidation-reduction reaction in which the fuel is oxidized by the oxygen in the fuel electrode and the oxygen electrode occurs, and a part of chemical energy of the fuel is converted into electric energy to be extracted.

Various types of fuel cells have been already proposed or experimentally produced, and some of the fuel cells have been put into practical use. Depending on used electrolytes, these fuel cells are classified into an Alkaline Fuel Cell (AFC), a Phosphoric Acid Fuel Cell (PAFC), a Molten Carbonate Fuel Cell (MCFC), a Solid Electrolyte Fuel Cell (SOFC), a Polymer Electrolyte Fuel Cell (PEFC), and the like. Among them, in comparison with the other types of the fuel cells, the PEFC may be operated at a low temperature, for example, at a temperature approximately from 30° C. to 130° C. both inclusive.

As the fuel of the fuel cell, various combustible substances such as hydrogen and methanol may be used. However, since a storage cylinder or the like is necessary for a gas fuel such as hydrogen, it is not suitable for size reduction. Meanwhile, a liquid fuel such as methanol has an advantage that it is easily stored. Especially, in a Direct Methanol Fuel Cell (DMFC), a reformer for extracting hydrogen from the fuel is not necessary and the configuration is simple so that there is an advantage that the size reduction is easy.

In the DMFC, the methanol as the fuel is typically supplied to the fuel electrode as a low-concentrated or high-concentrated water solution, or as pure methanol in the gas state, and oxidized into carbon dioxide in a catalyst layer of the fuel electrode. A proton (H+) generated at this time passes through an electrolyte film separating the fuel electrode and the oxygen electrode to be transferred to the oxygen electrode, and reacts with the oxygen in the oxygen electrode to generate water. The reaction generated in the fuel electrode, the oxygen electrode, and the whole DMFC is represented by chemical formula 1.

Fuel electrode: CH₃OH+H₂O→CO₂+6e⁻+6H⁺

Oxygen electrode: ( 3/2)O₂+6e⁻+6H⁺→3H₂O

Whole DMFC: CH₃OH+( 3/2)O₂→CO₂+2H₂O (Chemical Formula 1)

The energy density of the methanol as the fuel of the DMFC is theoretically 4.8 kW/L, and is ten times or more of the energy density of a typical lithium ion secondary cell. That is, the fuel cell using the methanol as the fuel has a great potential to exceed the lithium ion secondary cell in the energy density. From these, among various fuel cells, the DMFC has the highest possibility to be used as the energy source for a mobile device, an electric car, and the like.

However, there is an issue in the DMFC that although the theoretical voltage is 1.23 V, the output voltage at the time of actual power generation is reduced to approximately 0.6 V or less. The reduction in the output voltage is caused by the voltage drop generated by internal resistance of the DMFC, and internal resistance such as resistance accompanied by reaction generated in both electrodes, resistance accompanied by transfer of substances, resistance generated when the proton is transferred from the electrolyte film, and, further, contact resistance exists in the DMFC. Since the energy which may be actually extracted as the electric energy from oxidation of the methanol is represented by a product of the output voltage at the time of the power generation and the electricity amount flowing through a circuit, when the output voltage at the time of the power generation is reduced, the energy which may be actually extracted is reduced correspondingly. In addition, the electricity amount which may be extracted to the circuit by the oxidation of the methanol is proportional to the methanol amount in the DMFC when the whole amount of methanol is oxidized in the fuel electrode in accordance with chemical formula 1.

Also, there is an issue of methanol crossover in the DMFC. The methanol crossover is a phenomenon that the methanol transmits the electrolyte film from the fuel electrode side, and reaches the oxygen electrode side by two mechanisms of a phenomenon that the methanol is diffused and transferred by the difference of the methanol concentration on the fuel electrode side and the oxygen electrode side, and an electroosmotic phenomenon that the hydrated methanol is carried by transfer of the water accompanied by transfer of the proton.

When the methanol crossover is generated, the transmitted methanol is oxidized in the catalyst layer of the oxygen electrode. The methanol oxidation reaction on the oxygen electrode side is the same as the oxidation reaction on the fuel electrode side, and causes the reduction in the output voltage of the DMFC (for example, refer to Non-patent Document 1). Also, since the methanol is not used for the power generation on the fuel electrode side, and is consumed on the oxygen electrode side, the electricity amount which may be extracted to the circuit is reduced correspondingly. Further, since the catalyst layer of the oxygen electrode is not an alloy catalyst of platinum (Pt)-ruthenium (Ru), but is a platinum (Pt) catalyst, carbon monoxide (CO) is likely to be absorbed on the surface of the catalyst, and there is a disadvantage that catalyst poisoning is generated, or the like.

In this manner, in the DMFC, there are two issues of the voltage reduction caused by the internal resistance and the methanol crossover, and consumption of the fuel caused by the methanol crossover, and these cause the reduction in the power generation efficiency of the DMFC. Thus, to increase the power generation efficiency of the DMFC, study and development to improve characteristics of the material constituting the DMFC, and study and development to optimize the operation conditions of the DMFC are energetically conducted.

In the study to improve the characteristics of the material constituting the DMFC, there is the study of the electrolyte film and the catalyst on the fuel electrode side. For the electrolyte film, although a polyperfluoroalkyl sulfonic acid-based resin film (“Nafion (registered trademark)” manufactured by Du Pont) is typically used today, a fluoropolymer film, a hydrocarbon polymer electrolyte film, a hydrogel based electrolyte film, or the like is considered because of the proton conductivity and the methanol transmission inhibition capability which are higher than those of the polyperfluoroalkyl sulfonic acid-based resin film. Also, in addition to those, a film formed by doping an organic compound having a sulfonic acid group or a phosphonic acid group with a polymer compound (for example, refer to Patent Documents 1 to 3), and a film using a polymer compound having the sulfonic acid group or the phosphonic acid group (for example, Patent Documents 4 and 5) are known as the electrolyte film, and, further, an organic compound having the sulfonic acid group or the phosphonic acid group is known as a material for forming the electrolyte film (for example, Patent Documents 6 and 7).

For the catalyst on the fuel electrode side, study and development of a catalyst more highly activated than the platinum (Pt)-ruthenium (Ru) alloy catalyst which is typically used today have been conducted.

Such characteristics improvement of the material constituting the fuel cell is appropriate as a means of improving the power generation efficiency of the fuel cell. However, similarly to the situation that a catalyst most suitable for eliminating the above-described two issues has not been found, a most suitable electrolyte film has not been found so far.
Non-patent Document 1: “Fuel Cell Systems Explained”, Ohmsha, p. 66
Non-patent Document 2: “Journal of the American Chemical Society” 2005, Vol 127, No. 48, pp. 16758-16759
Non-patent Document 3: “Commercialization of fuel cells for mobile devices”, Technical Information Institute Co., Ltd., p. 110
Patent Document 1: Japanese Unexamined Patent Publication No. 2006-260993
Patent Document 2: Japanese Unexamined Patent Publication No. 2006-299075
Patent Document 3: Japanese Unexamined Patent Publication No. 2007-012617
Patent Document 4: Japanese Unexamined Patent Publication No. 2000-011755
Patent Document 5: Japanese Unexamined Patent Publication No. 2003-020308
Patent Document 6: Japanese Unexamined Patent Publication No. 2002-338585
Patent Document 7: Japanese Unexamined Patent Publication No. 2005-222890
Patent Document 8: U.S. Patent Publication No. 2004/0072047

Meanwhile, in Non-patent Document 2 and Patent Document 8, the issues are not attempted to be solved by the existing method such as development of the electrolyte film, but a fuel cell using a laminar flow (laminar flow) (laminar flow fuel cell) is proposed. In the laminar flow fuel cell, it is said that the issues such as flooding in the oxygen electrode, water control, crossover of the fuel, and the like may be solved.

As conditions that the laminar flow occurs, a low Reynolds number (Reynolds Number=Re) is cited. The Reynolds number is a ratio of an inertial term and a viscous term, and is represented by formula 1. Typically, when Re is less than 2000, it is said that the flow is the laminar flow.

Re=(inertial force/viscous force)=ρUL/μ=UL/ν (Formula 1)

(In the formula, ρ represents a fluid density, U represents a representative speed, L represents a representative length, μ represents a viscous coefficient, and ν represents a kinetic viscosity, respectively).

In the laminar flow fuel cell, a micropath is used. In that micropath, two types or more fluids flow by the laminar flow. That is, since the fluids have characteristics of the laminas flow, the fluids form an interface and flow without mixing up. Power generation is continuously possible by sticking the fuel electrode and the oxygen electrode onto a wall in the path, and circulating, by the laminas flow, liquid of the fuel and an electrolyte solution, and water containing oxygen or liquid containing only the electrolyte solution when the oxygen electrode is porous. As understood from this, the interface of the laminar flow serves as the electrolyte film, and ionic contact occurs. Therefore, the electrolyte film is not necessary in this structure, and it is possible to omit the reduction in the power generation efficiency caused by deterioration of the electrolyte film which is held in the existing fuel cell.

However, in this structure, sulfuric acid is used as the fluid containing the electrolyte. Although this sulfuric acid is diluted sulfuric acid in which the concentration is approximately from 0.5 mol/dm³ to 1 mol/dm³ both inclusive, the sulfuric acid is nonvolatile unlike hydrochloric acid or the like, and there is a risk that an issue of safety is generated even in the sulfuric acid having the low concentration. For example, there is a possibility that the water is evaporated depending on environment of the power generation. In that case, the diluted sulfuric acid is changed to the concentrated sulfuric acid, and corrosion may be caused when a portion in contact with a cell package or the fluid is a metal. Also, although the member is a resin, there is a small number of members resistant to the concentrated sulfuric acid. Therefore, a probability that the laminar flow fuel cell using the sulfuric acid as the electrolyte is put into practical use is extremely small.

In view of the foregoing problems, it is desired to provide an ion conductor capable of ensuring high safety, for example, even when being influenced by an environmental change, and capable of obtaining a favorable ion conductivity. Also, it is desired to provide a fuel cell capable of ensuring high safety, and capable of obtaining favorable characteristics such as a power density.

### SUMMARY

An ion conductor of an embodiment includes: an organic compound which is solid at a room temperature, and which has at least one of a sulfonic acid group and a phosphonic acid group; and a solvent dissolving the organic compound. “Room temperature” denotes a temperature range from 25° C. to 30° C. both inclusive, and “solid at a room temperature” denotes that a melting point thereof is higher than 30° C.

In the fuel cell of the embodiment, a fuel electrode and an oxygen electrode are oppositely arranged with an electrolyte in between, and the electrolyte is composed of the ion conductor including the organic compound which is solid at the room temperature and which has at least one of the sulfonic acid group and the phosphonic acid group, and the solvent dissolving the organic compound.

In the ion conductor of the embodiment, since the organic compound which is solid at the room temperature and which has at least one of the sulfonic acid group and the phosphonic acid group is dissolved, a proton is dissociated from the sulfonic acid group or the phosphonic acid group, and favorable ion conductivity is exhibited as a whole. Also, for example, in the case where the solvent is evaporated due to the environmental change, that organic compound remains as solid. Thereby, in the fuel cell of the present invention using the above-described ion conductor, the resistance between the fuel electrode and the oxygen electrode is suppressed low, and the fuel is favorably converted into electric energy. Also, unlike sulfuric acid used as an existing electrolyte fluid, even in the case where the solvent is evaporated, a surrounding member is unlikely to be corroded.

According to the ion conductor of the embodiment, since the ion conductor includes the organic compound which is solid at the room temperature and which has at least one of the sulfonic acid group and the phosphonic acid group, and the solvent dissolving the organic compound, for example, it is possible to ensure high safety even when being influenced by the environmental change, and it is possible to obtain the favorable ion conductivity. Thereby, according to the fuel cell using the ion conductor of the embodiment as the electrolyte, it is possible to ensure the high safety, and it is possible to obtain the favorable characteristics such as the power density.

Additional features and advantages are described herein, and will be apparent from, the following Detailed Description and the figures.

### BRIEF DESCRIPTION OF THE FIGURES

FIG. 1 is a view illustrating the schematic configuration of an electric device including a first fuel cell system according to an embodiment.

FIG. 2 is a view illustrating the configuration of a fuel cell illustrated in FIG. 1.

FIG. 3 is a view illustrating the configuration of the fuel cell according to another embodiment.

FIG. 4 is a view illustrating characteristics of a fuel cell system manufactured in an example.

FIG. 5 is a view illustrating characteristics of another fuel cell system manufactured in an example.

FIG. 6 is a view illustrating characteristics of still another fuel cell system manufactured in an example.

FIG. 7 is a view further illustrating characteristics of still another fuel cell system manufactured in an example.

FIG. 8 is a view further illustrating characteristics of still another fuel cell system manufactured in an example.

### DETAILED DESCRIPTION

A description will be hereinafter made on an embodiment.

An ion conductor according to the embodiment is a liquid electrolyte (electrolyte solution) used in an electrochemical device such as a fuel cell, and contains an organic compound which is solid at a room temperature and which has at least one of a sulfonic acid group and a phosphonic acid group (hereinafter, referred to as an organic compound having a sulfonic acid group or the like), and a solvent dissolving the organic compound having the sulfonic acid group or the like. This ion conductor may contain only one kind of the organic compounds having the sulfonic acid group or the like, or may contain two kinds or more by mixing them.

This ion conductor contains the organic compound having the sulfonic acid group or the like. This is because the favorable ion conductivity may be obtained, since the organic compound having the sulfonic acid group or the like has at least one of the sulfonic acid group and the phosphonic acid group exhibiting the high proton dissociation, and the high safety may be ensured in comparison with sulfuric acid or the like, since the organic compound having the sulfonic acid group or the like is solid at the room temperature, and remains as solid even in the case where the solvent is evaporated due to the environmental change.

The organic compound having the sulfonic acid group or the like is a compound having the ion conductivity. Although this organic compound having the sulfonic acid group or the like is arbitrary as long as it is solid at the room temperature, that is, as long as the melting point of that compound is 30° C. or more, it is preferable for the organic compound having the sulfonic acid group or the like to have the melting point higher than the operation temperature and the use temperature assumed in the electrochemical device such as the fuel cell. This is because even in the case where the solvent is evaporated at the assumed operation temperature and the assumed use temperature, corrosion of a surrounding member is suppressed, and the higher safety may be ensured. Therefore, for example, since the operation temperature assumed in the direct methanol fuel cell is from 30° C. to 130° C. both inclusive, the melting point of the organic compound having the sulfonic acid group or the like is preferably higher than 130° C.

Also, the organic compound having the sulfonic acid group or the like may have at least only one of the sulfonic acid group and the phosphnic acid group, may have two or more of the sulfonic acid group or the phosphonic acid group, or may have two or more of the sulfonic acid group and the phosphonic acid group in total. Among them, the organic compound having the sulfonic acid group or the like preferably has two or more of either one of the sulfonic acid group or the phosphonic acid group. This is because the more favorable ion conductivity may be obtained.

Examples of the organic compound having the sulfonic acid group or the like include a compound in which at least one of the sulfonic acid group and the phosphonic acid group is linked to a chain or branched carbon chain, and a compound in which at least one of the sulfonic acid group and the phosphonic acid group is linked to a carbon ring or a heterocyclic ring. Specifically, there are a compound having at least one of the sulfonic acid group and the phosphonic acid group, and a straight-chain or branched carbon skeleton, a compound having at least one of the sulfonic acid group or the phosphonic acid group, and a benzene ring, a pyridine ring, a naphthalene ring, a quinoline ring, or an isoquinoline ring, and the like. Among them, the organic compound having the sulfonic acid group or the like preferably contains at least one of the compounds represented by chemical formula 2 to chemical formula 7. This is because a high effect may be obtained.

In addition, R1 and R2 in chemical formula 2 may be the same as each other, or may be different from each other. R3 in chemical formula 2 may be the same as each other, or may be different from each other. Same is true for R4 to R9 in chemical formula 3, R10 to R14 in chemical formula 4, R15 to R22 in chemical formula 5, R23 to R29 in chemical formula 6, and R30 to R36 in chemical formula 7.

R1-CₙR3₂ₙ-R2 [Chemical Formula 2]

(where each R1 to R3 is a hydrogen group (—H), a hydroxy group (—OH), an amino group (—NH₂), an aminoalkyl group, a cyano group (—CN), a halogen group, a sulfonic acid group or a phosphonic acid group. However, at least one of R1, R2, and R3 is the sulfonic acid group or the phosphonic acid group. n is an integer from 1 to 10 both inclusive).

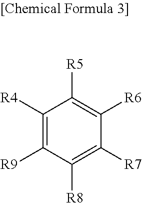

(where each R4 to R9 is a hydrogen group, a hydroxy group, an amino group, an aminoalkyl group, a cyano group, a halogen group, an alkyl group, an alkoxy group, a sulfonic acid group or a methylphosphonic acid group (—CH₂—PO₃H₂). However, at least one of R4, R5, R6, R7, R8, and R9 is the sulfonic acid group or the methylphosphonic acid group).

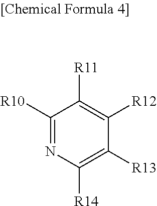

(where each R10 to R14 is a hydrogen group, a hydroxy group, an amino group, an aminoalkyl group, a cyano group, a halogen group, an alkyl group, an alkoxy group, a sulfonic acid group or a methylphosphonic acid group. However, at least one of R10, R11, R12, R13, and R14 is the sulfonic acid group or the methylphosphonic acid group).

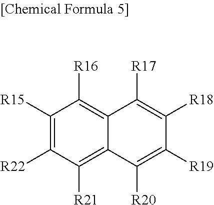

(where each R15 to R22 is a hydrogen group, a hydroxy group, an amino group, an aminoalkyl group, a cyano group, a halogen group, an alkyl group, an alkoxy group, a sulfonic acid group or a methylphosphonic acid group. However, at least one of R15, R16, R17, R18, R19, R20, R21 and R22 is the sulfonic acid group or the methylphosphonic acid group).

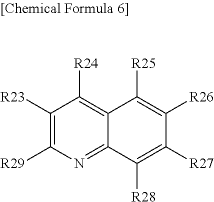

(where each R23 to R29 is a hydrogen group, a hydroxy group, an amino group, an aminoalkyl group, a cyano group, a halogen group, an alkyl group, an alkoxy group, a sulfonic acid group or a methylphosphonic acid group. However, at least one of R23, R24, R25, R26, R27, R28, and R29 is the sulfonic acid group or the methylphosphonic acid group).

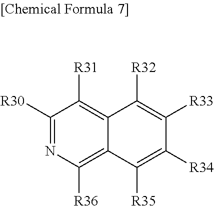

(where each R30 to R36 is a hydrogen group, a hydroxy group, an amino group, an aminoalkyl group, a cyano group, a halogen group, an alkyl group, an alkoxy group, a sulfonic acid group or a methylphosphonic acid group. However, at least one of R30, R31, R32, R33, R34, R35, and R36 is the sulfonic acid group or the methylphosphonic acid group).

Each R1 to R3 is the above-described hydrogen group or the like, since the high effect may be obtained. Among the above-described hydrogen group and the like, each R1 to R3 is preferably the hydrogen group, the halogen group, the sulfonic acid group or the phosphonic acid group. This is because the higher proton conductivity may be obtained. In the case where any of R1 to R3 is the halogen group, a fluorine group is preferable, since the higher effect may be obtained in comparison with other halogen groups. Also, in the case where any of R1 to R3 is the aminoalkyl group, the carbon number of the aminoalkyl group is preferably from 1 to 3 both inclusive. This is because when the carbon number is 4 or more, the melting point is likely to be decreased. Also, n in chemical formula 2 is within the above-described range, since the melting point is likely to be increased. Within the range, n is preferably an integer from 1 to 7 both inclusive, and more preferably an integer from 2 to 4 both inclusive. This is because the high effect may be obtained.

Each R4 to R9 is the above-described hydrogen group or the like, since the high effect may be obtained. Among the above-described hydrogen group and the like, each R4 to R9 is preferably the hydrogen group, the halogen group, the sulfonic acid group or the methylphosphonic acid group. This is because the higher proton conductivity may be obtained. In the case where any of R4 to R9 is the halogen group, the fluorine group is preferable, since the higher effect may be obtained in comparison with other halogen groups. Also, in the case where any of R4 to R9 is the aminoalkyl group, the alkyl group, or the alkoxy group, the carbon number thereof is preferably from 1 to 3 both inclusive. This is because when the carbon number is 4 or more, the melting point is likely to be decreased. Same is true for R10 to R14 in chemical formula 4, R15 to R22 in chemical formula 5, R23 to R29 in chemical formula 6, and R30 to R36 in chemical formula 7.

Examples of the compound represented by chemical formula 2 include a series of compounds represented by chemical formulas 8(1) to (10). Among them, at least one kind of the compounds of chemical formula 8(2) and chemical formula 8(10) is preferable, and the compound of chemical formula 8(2) is particularly preferable. This is because the higher effect may be obtained. In addition, needless to say, it is not limited to the compound represented by chemical formula 8, as long as it has the structure represented by chemical formula 2.

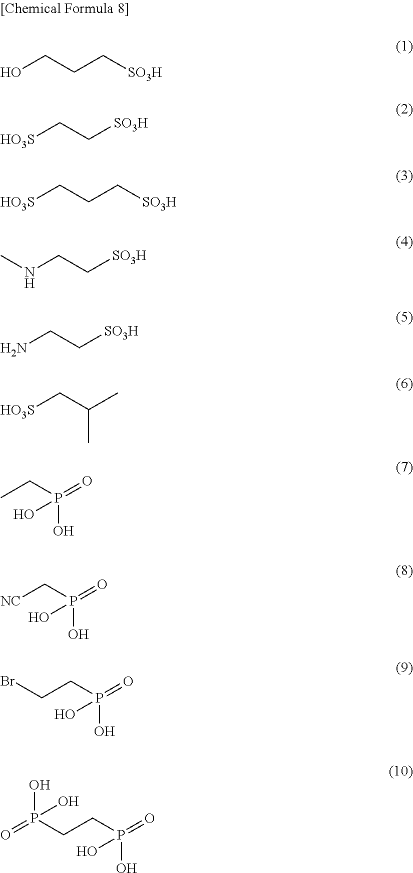

Examples of the compound represented by chemical formula 3 include a series of compounds represented by chemical formula 9 and chemical formula 10. Among them, at least one kind of the compounds of chemical formula 9(2), chemical formula 9(10), and chemical formula 10(2) is preferable, and at least one kind of the compounds of chemical formula 9(2) and chemical formula 9(10) is particularly preferable. This is because the higher effect may be obtained. In addition, it is not limited to the compounds represented by chemical formula 9 and chemical formula 10, as long as it has the structure represented by chemical formula 3.

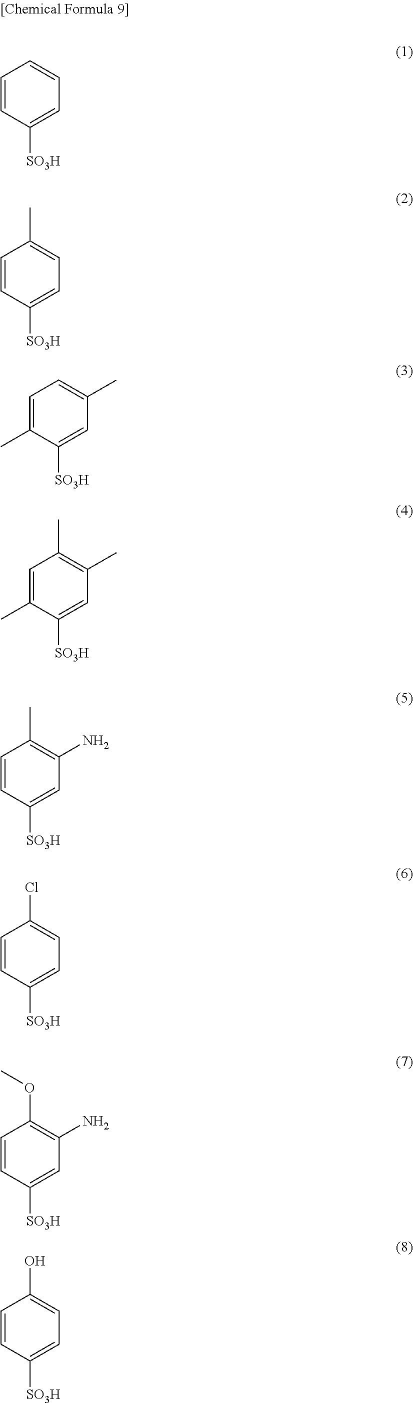

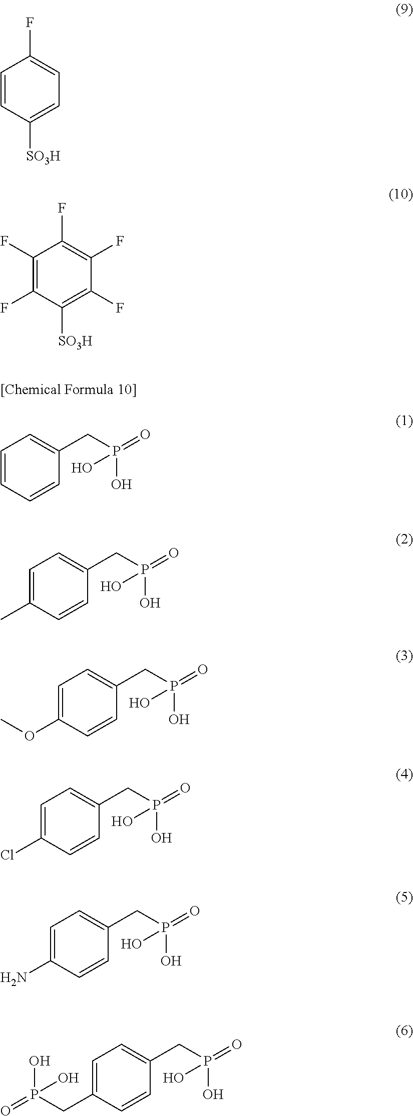

Examples of the compound represented by chemical formula 4 include the compound represented by chemical formula 11. In addition, it is not limited to the compound represented by chemical formula 11, as long as it has the structure represented by chemical formula 4.

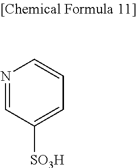

Examples of the compound represented by chemical formula 5 include a series of compounds represented by chemical formula 12(1) to (4). Among them, the compound of chemical formula 12(2) is preferable. This is because the high effect may be obtained. In addition, needless to say, it is not limited to the compound represented by chemical formula 12, as long as it has the structure represented by chemical formula 5.

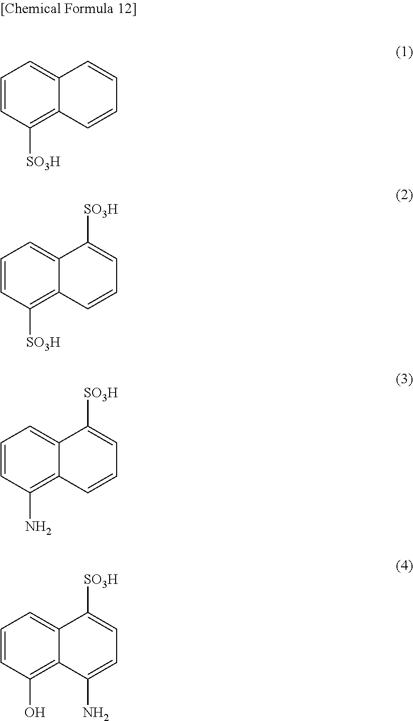

Examples of the compound represented by chemical formula 6 include the compound represented by chemical formula 13. In addition, it is not limited to the compound represented by chemical formula 13, as long as it has the structure represented by chemical formula 6.

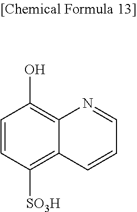

Examples of the compound represented by chemical formula 7 include the compound represented by chemical formula 14. In addition, it is not limited to the compound represented by chemical formula 14, as long as it has the structure represented by chemical formula 7.

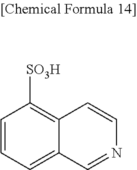

The content of the above-described organic compound having the sulfonic acid group or the like in the ion conductor is preferably from 0.1 mol/dm³ to 3 mol/dm³ both inclusive. This is because the favorable ion conductivity may be obtained.

The solvent is arbitrary, as long as it may dissolve the above-described organic compound having the sulfonic acid group or the like, and examples include water.

pH in this ion conductor is preferably 3 or less. This is because the high ion conductivity may be obtained.

According to this ion conductor, since the organic compound which is solid at the room temperature, and which has at least one of the sulfonic acid group and the phosphonic acid group is dissolved, the proton is dissociated from the sulfonic acid group or the phosphonic acid group, and the favorable ion conductivity is exhibited as a whole. Also, in the case where the solvent is evaporated due to the environmental change, that organic compound remains as solid. Thereby, even when the influence of the environmental change is received, it is possible to ensure the high safety, and it is possible to obtain the favorable ion conductivity. Therefore, in the case where this ion conductor is used as the electrolyte in the electrochemical device such as the fuel cell, it is possible to ensure the high safety and it is possible to obtain the favorable characteristics such as the power density.

In particular, when the organic compound having at least one of the sulfonic acid group and the phosphonic acid group is at least one kind selected from the group consisting of the compounds represented by chemical formula 2 to chemical formula 7, the high effect may be obtained.

Next, as a use example of the above-described ion conductor, the case where the ion conductor is used in a fuel cell system including the fuel cell will be described.

(First Fuel Cell System)

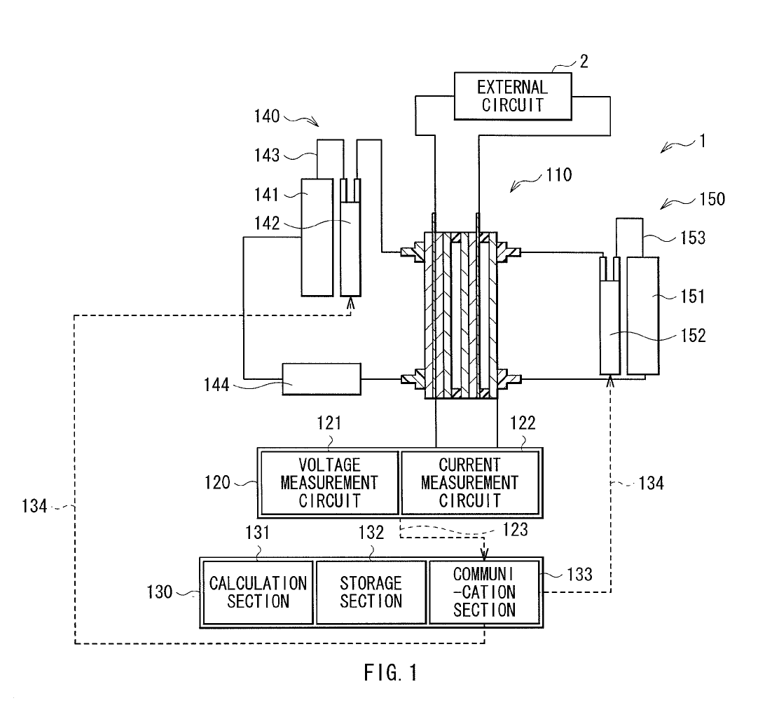

FIG. 1 illustrates the schematic configuration of an electric device having a first fuel cell system. This electric device is, for example, a mobile device such as a cell phone and a PDA (Personal Digital Assistant), or a notebook PC (Personal Computer), and includes a fuel cell system 1 and an external circuit (load) 2 driven by electric energy generated in this fuel cell system 1.

The fuel cell system 1 includes, for example, a fuel cell 110, a measurement section 120 measuring the operation status of this fuel cell 110, and a control section 130 determining the operation condition of the fuel cell 110 based on a measurement result by the measurement section 120. This fuel cell system 1 also includes an electrolyte supply section 140 supplying a first fluid F1 containing an electrolyte to the fuel cell 110, and a fuel supply section 150 supplying a second fluid F2 containing the fuel. In this manner, since the electrolyte film is not necessary by supplying the electrolyte as the fluid, it is possible to generate electricity without being influenced by the temperature and the humidity, and it is possible to increase the ion conductivity (proton conductivity) in comparison with a typical fuel cell using the electrolyte film. In the electrolyte film, it is necessary to add a binder to the resin having the ion conductivity (proton conductivity) for the purpose of fixing, since the ion conductivity (proton conductivity) is highly decreased from the bulk state. Also, the risk that the electrolyte film is deteriorated and the proton conductivity is reduced due to dryness of the electrolyte film is eliminated, and it is possible to solve an issue of flooding in the oxygen electrode, water control, and the like.

The electrolyte contained in the first fluid F1 is composed of the above-described ion conductor. Thereby, in this fuel cell 110, the first fluid F1 containing the electrolyte has the favorable ion conductivity, and it is possible to suppress the resistance between the fuel electrode and the oxygen electrode low. Also, unlike the case where the sulfuric acid is used as the electrolyte as in the existing manner, even in the case where the solvent is evaporated, the surrounding member is unlikely to be corroded. Thus, the high safety may be ensured, and the favorable characteristics such as the power density may be obtained.

Examples of the fuel contained in the second fluid F2 include methanol. In addition, the second fluid F2 containing the fuel may be other alcohol such as ethanol, and dimethyl ether, in substitution for methanol.

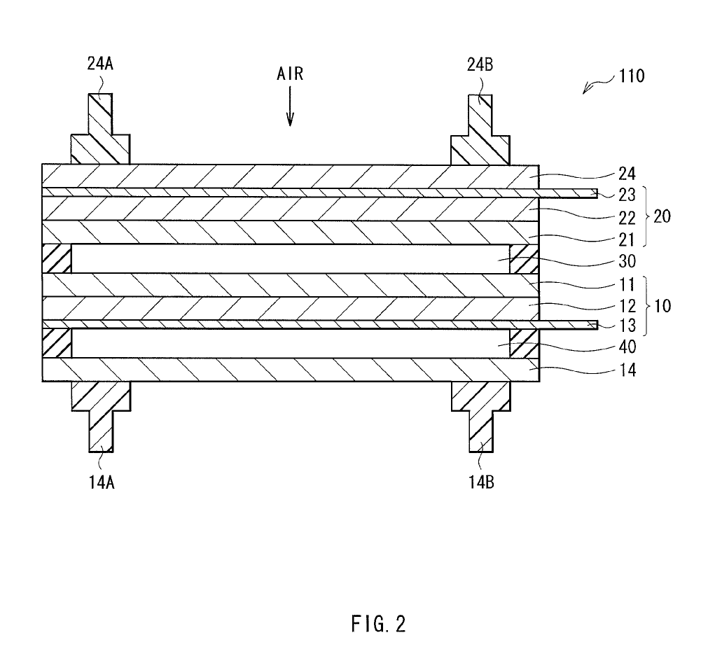

FIG. 2 illustrates the configuration of the fuel cell 110 illustrated in FIG. 1. The fuel cell 110 is a so-called Direct Methanol Flow Based Fuel Cell (DMFFC; Direct Methanol Flow Based Fuel Cell), and has the configuration in which a fuel electrode (anode) 10 and an oxygen electrode (cathode) 20 are oppositely arranged. Between the fuel cell 10 and the oxygen electrode 20, an electrolyte path 30 flowing the first fluid F1 containing the electrolyte is provided. Outside the fuel electrode 10, that is, on the opposite side from the oxygen electrode 20, a fuel path 40 flowing the second fluid F2 containing the fuel is provided. That is, the fuel electrode 10 also serves as a separation film separating the first fluid F1 containing the electrolyte, and the second fluid F2 containing the fuel.

The fuel cell 10 has the configuration in which a catalyst layer 11, a diffusion layer 12, and a current collector 13 are stacked in order from the oxygen electrode 20 side, and is stored in an external member 14. The oxygen electrode 20 has the configuration in which a catalyst layer 21, a diffusion layer 22, and a current collector 23 are stacked in order from the fuel electrode side, and is stored in an external member 24. In addition, air, that is, oxygen is supplied to the oxygen electrode 20 through this external member 24.

As the catalysts, the catalyst layers 11 and 21 are composed of, for example, a metal as a simple substance of palladium (Pd), platinum (Pt), iridium (Ir), rhodium (Rh), ruthenium (Ru), or the like, or an alloy of these. Also, in addition to the catalysts, a proton conductor and the binder may be contained in the catalyst layers 11 and 21. Examples of the proton conductor include a polyperfluoroalkyl sulfonic acid-based resin film (“Nafion (registered trademark)” manufactured by Du Pont), or other resins having the proton conductivity. The binder is added to hold intensity and flexibility of the catalyst layers 11 and 21, and examples of the binder include a resin of polytetrafluoroethylene (PTFE), polyvinylidene fluoride (PVDF), or the like.

The diffusion layers 12 and 22 are, for example, composed of carbon cloth, carbon paper, or a carbon sheet. Water repellent treatment by polytetrafluoroethylene (PTEE) or the like is desirably performed on the diffusion layers 12 and 22.

The content collectors 13 and 23 are, for example, composed of titanium (Ti) mesh.

The external members 14 and 24 have, for example, a thickness of 2.0 mm, and are composed of a material which is generally available, such as a titanium plate, however, the material is not specifically limited. In addition, the eternal members 14 and 24 are desirably as small as possible in thickness.

The electrolyte path 30 and the fuel path 40 are, for example, formed by fine paths by processing a resin sheet, and are bonded to the fuel electrode 10. In addition, the number of paths is not limited. Also, although the width, the height, and the length of the path are not specifically limited, they are desirably as small as possible.

The electrolyte path 30 is connected to the electrolyte supply section 140 (not illustrated in FIG. 2, refer to FIG. 1) through an electrolyte inlet 24A and an electrolyte outlet 24B provided in the external member 24, and the first fluid F1 containing the electrolyte is supplied from the electrolyte supply section 140 to the electrolyte path 30. The fuel path 40 is connected to the fuel supply section 150 (not illustrated in FIG. 2, refer to FIG. 1) through a fuel inlet 14A and a fuel outlet 14B provided in the external member 14, and the second fluid F2 containing the fuel is supplied from the fuel supply section 150 to the fuel path 40.

The measurement section 120 illustrated in FIG. 1 measures an operation voltage and an operation current of the fuel cell 110, and has, for example, a voltage measurement circuit 121 measuring the operation voltage of the fuel cell 110, a current measurement circuit 122 measuring the operation current, and a communication line 123 sending the obtained measurement result to the control section 130.

The control section 130 illustrated in FIG. 1 controls an electrolyte supply parameter and a fuel supply parameter as operation conditions of the fuel cell 110 based on the measurement result of the measurement section 120, and has, for example, a calculation section 131, a storage (memory) section 132, a communication section 133 and a communication line 134. Here, the electrolyte supply parameter includes, for example, a supply flow rate of the fluid F1 containing the electrolyte. The fuel supply parameter includes, for example, a supply flow rate and a supply amount of the fluid F2 containing the fuel, and may include a supply concentration according to needs. The control section 130 may, for example, be composed of a microcomputer.

The calculation section 131 calculates an output of the fuel cell 110 from the measurement result obtained in the measurement section 120, and sets the electrolyte supply parameter and the fuel supply parameter. Specifically, the calculation section 131 averages an anode potential, a cathode potential, an output voltage and an output current sampled at regular intervals from the various measurement results input to the storage section 132, calculates an average anode potential, an average cathode potential, an average output voltage, and an average output current to input them to the storage section 132, and mutually compares the various average values stored in the storage section 132 to determine the electrolyte supply parameter and the fuel supply parameter.

The storage section 132 stores the various measurement values sent from the measurement section 120, the various average values calculated by the calculation section 131, and the like.

The communication section 133 has a function to receive the measurement result from the measurement section 120 through the communication line 123, and to input the measurement result to the storage section 132, and has a function to output signals for setting the electrolyte supply parameter and the fuel supply parameter to the electrolyte supply section 140 and the fuel supply section 150 through the communication line 134, respectively.

The electrolyte supply section 140 illustrated in FIG. 1 includes an electrolyte storage section 141, an electrolyte supply adjustment section 142, an electrolyte supply line 143, and a separation chamber 144. The electrolyte storage section 141 stores the first fluid F1 containing the electrolyte, and is composed of, for example, a tank or a cartridge. The electrolyte supply adjustment section 142 adjusts the supply flow rate of the first fluid F1 containing the electrolyte. Although the electrolyte supply adjustment section 142 is not specifically limited as long as it may be driven by a signal from the control section 130, the electrolyte supply adjustment section 142 is preferably composed of, for example, a valve driven by a motor or a piezoelectric element, or an electromagnetic pump. There is a possibility that a small amount of methanol is mixed in the first fluid F1 containing the electrolyte which comes out from the electrolyte outlet 24B, and thus the separation chamber 144 separates that methanol. The separation chamber 144 is provided in the vicinity of the electrolyte outlet 24B, and includes, as a methanol separation mechanism, a mechanism to remove a filter or the methanol by burning, reaction, or evaporation.

The fuel supply section 150 illustrated in FIG. 1 includes an fuel storage section 151, a fuel supply adjustment section 152, and a fuel supply line 153. The fuel storage section 151 stores the second fluid F2 containing the fuel, and is composed of, for example, a tank or a cartridge. The fuel supply adjustment section 152 adjusts the supply flow rate and the supply amount of the second fluid F2 containing the fuel. Although the fuel supply adjustment section 152 is not specifically limited as long as it may be driven by a signal from the control section 130, the fuel supply adjustment section 152 is preferably composed of, for example, a valve driven by a motor or a piezoelectric element, or an electromagnetic pump. In addition, the fuel supply section 150 may include a concentration adjustment section (not illustrated in the figure) adjusting the supply concentration of the second fluid F2 containing the fuel. The concentration adjustment section may be omitted in the case where pure (99.9%) methanol is used as the second fluid F2 containing the fuel, and more size reduction is possible.

This fuel cell system 1 may be manufactured, for example, as will be described next.

First, as a catalyst, for example, an alloy containing platinum and ruthenium at a predetermined ratio, and a dispersion solution of a polyperfluoroalkyl sulfonic acid-based resin film (“Nafion (registered trademark)” manufactured by Du Pont) are mixed at a predetermined ratio, and the catalyst layer 11 of the fuel electrode 10 is formed. This catalyst layer 11 is thermally compression bonded to the diffusion layer 12 made of the above-described material. Further, the current collector 13 made of the above-described material is thermally compression bonded by using a hot-melt adhesive, or an adhesive resin sheet, and the fuel electrode 10 is formed.

Also, as the catalyst, platinum (Pt) carried by carbon, and the dispersion solution of the polyperfluoroalkyl sulfonic acid-based resin film (“Nafion (registered trademark)” manufactured by Du Pont) are mixed at a predetermined ratio, and the catalyst layer 21 of the oxygen electrode 20 is formed. This catalyst layer 21 is thermally compression bonded to the diffusion layer 22 made of the above-described material. Further, the current collector 23 made of the above-described material is thermally compression bonded by using the hot-melt adhesive or the adhesive resin sheet, and the oxygen electrode 20 is formed.

Next, the adhesive resin sheet is prepared, and the electrolyte path 30 and the fuel path 40 are fabricated by forming the paths in this resin sheet and are thermally compression bonded to both sides of the fuel electrode 10.

Next, the external members 14 and 24 of the above-described material are fabricated, the fuel inlet 14A and the fuel outlet 14B made of, for example, a resin joint are provided in the external member 14, and the electrolyte inlet 24A and the electrolyte outlet 24B made of, for example, a resin joint are provided in the external member 24.

After that, the fuel electrode 10 and the oxygen electrode 20 are oppositely arranged with the electrolyte path 30 between the both and with the fuel path 40 outside the both, and stored in the external members 14 and 24. Thereby, the fuel cell 110 illustrated in FIG. 2 is completed.

This fuel cell 110 is installed in a system having the measurement section 120, the control section 130, the electrolyte supply section 140, and the fuel supply section 150 having the above-described configuration, the fuel inlet 14A and the fuel outlet 14B, and the fuel supply section 150 are, for example, connected with the fuel supply line 153 made of a silicone tube, and the electrode inlet 24A and the electrode outlet 24B, and the electrode supply section 140 are, for example, connected with the electrolyte supply line 143 made of the silicone tube. As the first fluid F1 containing the electrolyte, the ion conductor is prepared by dissolving the above-described organic compound having the sulfonic acid group or the like in water as the solvent to have a predetermined concentration (for example, 1 mol/dm³), and is used as the electrolyte. Also, the methanol is used as the second fluid F2 containing the fuel. As described above, the fuel cell system 1 illustrated in FIG. 1 is completed.

In this fuel cell system 1, the second fluid F2 containing the fuel is supplied to the fuel electrode 10, and the proton and the electron are generated by reaction. The proton passes through the first fluid F1 containing the electrolyte to travel to the oxygen electrode 20, and generates water by reacting with the electron and oxygen. The reaction occurred in the fuel electrode 10, the oxygen electrode 20, and the whole fuel cell 110 is represented by chemical formula 15. Thereby, a part of chemical energy of the methanol as the fuel is converted into electric energy, a current is extracted from the fuel cell 110, and an external circuit 2 is driven. The carbon dioxide generated in the fuel electrode 10, and the water generated in the oxygen electrode 20 flow with the first fluid F1 containing the electrolyte, and are extracted.

Fuel electrode 10: CH₃OH+H₂O→CO₂+6e⁻+6H⁺

Oxygen electrode 20: ( 3/2)O₂+6e⁻+6H⁺→3H₂O

Whole fuel cell 110: CH₃OH+( 3/2)O₂→CO₂+2H₂O (Chemical Formula 15)

Also, by providing the fuel electrode 10 between the electrolyte path 30 and the fuel path 40, the reaction occurs when almost all the fuel passes through the fuel electrode 10. Supposedly, even in the case where the fuel in the unreacted state passes through the fuel electrode 10, the fuel is carried out from inside the fuel electrode 110 by the first fluid F1 containing the electrolyte before infiltrating into the oxygen electrode 20, and the fuel crossover is significantly suppressed. Therefore, it is possible to use the highly-concentrated fuel, and the high energy density characteristics as the primary advantage of the fuel cell are utilized.

During the operation of the fuel cell 110, the operation voltage and the operation current of the fuel cell 110 are measured by the measurement section 120, and the electrolyte supply parameter and the fuel supply parameter described above are controlled as the operation conditions of the fuel cell 110 by the control section 130 based on that measurement result. The measurement by the measurement section 120 and the parameter control by the control section 130 are frequently repeated, and the supply state of the first fluid F1 containing the electrolyte and the second fluid F2 containing the fuel is optimized by following the characteristics change of the fuel cell 110.

Here, since the above-described ion conductor is used as the electrolyte contained in the first fluid F1, the electrolyte has the favorable ion conductivity. Also, unlike the sulfuric acid used as the existing electrolyte fluid, in the case where the solvent is evaporated, the organic compound having the sulfonic acid group or the like remains as solid.

According to this fuel cell system, since the ion conductor in which the organic compound which is solid at the room temperature, and which has at least one of the sulfonic acid group and the phosphonic acid group is dissolved in the solvent is used as the electrolyte contained in the first fluid F1, it is possible to suppress the resistance between the fuel electrode 10 and the oxygen electrode 20 low. Also, unlike the sulfuric acid used as the existing electrolyte fluid, in the case where the solvent is evaporated, the surrounding member is unlikely to be corroded. Thus, the high safety may be ensured, and the favorable characteristics such as the power density may be obtained. Other effects regarding this fuel cell system are the same as those of the case of the above-described ion conductor.

(Second Fuel Cell System)

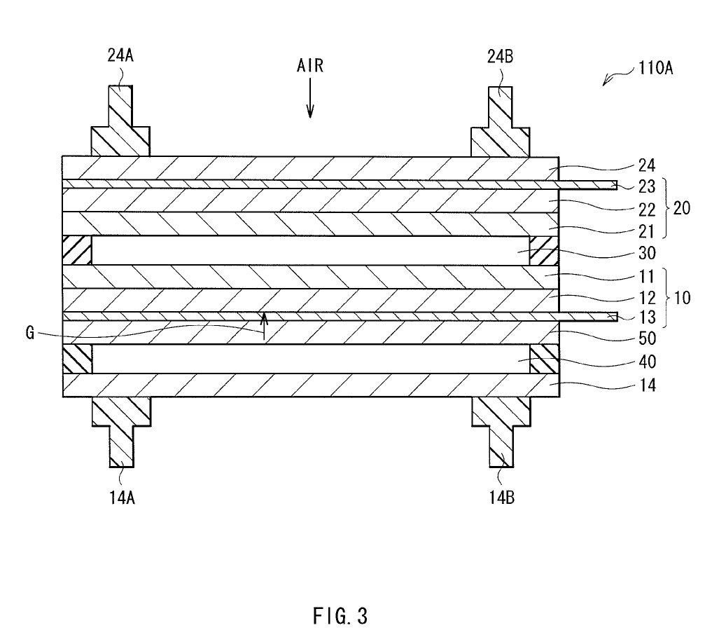

FIG. 3 illustrates the configuration of a fuel cell 110A included in a second fuel cell system. This fuel cell 110A has the same configuration as the fuel cell 110 included in the first fuel system except that a gas-liquid separation film 50 is provided between the fuel path 40 and the fuel electrode 10. Same reference numerals will be assigned to the components common to those of the first fuel cell system, and the description will be omitted.

The gas-liquid separation film 50 may be composed of, for example, a film of polytetrafluoroethylene (PTFE), polyvinylidene fluoride (PVDF), polypropylene (PP), or the like which does not allow transmission of alcohol in the liquid state.

This fuel cell 110A and the fuel cell system 1 using the fuel cell 110A may be manufactured in the same manner as the first fuel cell system 1 except that the gas-liquid separation film 50 is provided between the fuel path 40 and the fuel electrode 10.

In the second fuel cell system, in the same manner as the first fuel cell system, the current is extracted from the fuel cell 110A, and the external circuit 2 is driven. Here, since the gas-liquid separation film 50 is provided between the fuel path 40 and the fuel electrode 10, the pure methanol as the fuel is naturally volatilized in the liquid state when flowing through the fuel path 40, and passes through the gas-liquid separation film 50 in a gas G state from a face in contact with the gas-liquid separation film 50 to be supplied to the fuel electrode 10. Thus, the fuel is efficiently supplied to the fuel electrode 10, and the reaction stably occurs. Also, since the fuel is supplied to the fuel electrode 10 in the gas state, the electrode reaction activity is increased, the crossover is unlikely to be generated, and it is possible to obtain the high performance in the electric device having the high-load external circuit 2.

In addition, supposedly, even when the gas methanol passing through the fuel electrode 10 is existed, in the same manner as the first fuel cell system, the methanol is removed by the first fluid F1 containing the electrolyte before reaching the oxygen electrode 20.

In this fuel cell system, since the gas-liquid separation film 50 is provided between the fuel path 40 and the fuel electrode 10, it is possible to use pure (99.9%) methanol as the fuel contained in the second fluid F2, and it is possible to further utilize the high energy density characteristics as the characteristics of the fuel cell. Also, the reaction stability and the electrode reaction activity are increased, and it is possible to suppress the crossover. Thus, it is possible to obtain the high performance in the electric device having the high-load external circuit 2. Further, in the fuel supply section 150, it is possible to omit the concentration adjustment section adjusting the supply concentration of the second fluid F2 containing the fuel, and more size reduction is possible.

### EXAMPLES

Specific examples will be described in detail.

### Example 1

First, the above-described ion conductor was prepared. At that time, the solid compound of chemical formula 8(2) which was the compound represented by chemical formula 2 was dissolved in the water as the solvent, and the content of the compound of chemical formula 8(2) in the ion conductor was set to be 1 mol/dm³.

Next, the fuel cell 110A illustrated in FIG. 3 was fabricated. First, as the catalyst, the alloy containing platinum and ruthenium at the predetermined ratio, and the dispersion solution of the polyperfluoroalkyl sulfonic acid-based resin film (“Nafion (registered trademark)” manufactured by Du Pont) were mixed at the predetermined ratio, thereby the catalyst layer 11 of the fuel electrode 10 was formed. This catalyst layer 11 was thermally compression bonded to the diffusion layer 12 (manufactured by E-TEK; HT-2500) for 10 minutes under the condition that the temperature was 150° C. and the pressure was 249 kPa. Further, the content collector 13 made of a titanium mesh was thermally compression bonded by using the hot-melt adhesive, or the adhesive resin sheet, and the fuel electrode 10 was formed.

Also, as the catalyst, platinum carried by carbon, and the dispersion solution of the polyperfluoroalkyl sulfonic acid-based resin film (“Nafion (registered trademark)” manufactured by Du Pont) were mixed at the predetermined ratio, and the catalyst layer 21 of the oxygen electrode 20 was formed. This catalyst layer 21 was thermally compression bonded to the diffusion layer 22 (manufactured by E-TEK; HT-2500) in the same manner as the catalyst layer 11 of the fuel electrode 10. Further, the content collector 23 made of the titanium mesh was thermally compression bonded in the same manner as the content collector 13 of the fuel electrode 10, and the oxygen electrode 20 was formed.

Next, the adhesive resin sheet was prepared, and the electrolyte path 30 and the fuel path 40 were fabricated by forming the paths in this resin sheet and thermally compression bonded to both sides of the fuel electrode 10.

Next, the external members 14 and 24 made of titanium were fabricated, the fuel inlet 14A and the fuel outlet 14B made of the resin joint were provided in the external member 14, and the electrolyte inlet 24A and the electrolyte outlet 24B made of the resin joint were provided in the external member 24.

After that, the fuel electrode 10 and the oxygen electrode 20 were oppositely arranged with the electrolyte path 30 between the both and with the fuel path 40 outside the both, and stored in the external members 14 and 24. At that time, the gas-liquid separation film 50 (manufactured by Millipore) was provided between the fuel path 40 and the fuel electrode 10. Thereby, the fuel cell 110A illustrated in FIG. 3 was completed.

This fuel cell 110A was installed in the system having the measurement section 120, the control section 130, the electrolyte supply section 140, and the fuel supply section 150, and the fuel cell system 1 illustrated in FIG. 1 was composed. At that time, the electrolyte supply adjustment section 142 and the fuel supply adjustment section 152 were composed of diaphragm metering pumps (manufactured by KNF. Co., Ltd), the respective pumps were directly connected to the fuel inlet 14A and the electrolyte inlet 24A with the electrolyte supply line 143 and the fuel supply line 153 made of a silicone tube, and the first fluid F1 containing the electrolyte and the second fluid F2 containing the fuel were supplied to the electrolyte path 30 and the fuel path 40, respectively. At that time, as the electrolyte contained in the first fluid F1, the prepared ion conductor was used, and the flow rate of the first fluid F1 was 1.0 cm³/min. As the fuel contained in the second fluid F2, the pure (99.9%) methanol was used, and the flow rate was 0.80 cm³/min.

### Examples 2 to 5

In the same manner as example 1, the ion conductor was prepared and the fuel cell system 1 was composed by fabricating the fuel cell 110A except that the compound of chemical formula 8(10) (example 2), the compound of chemical formula 9(2) (example 3), the compound of chemical formula 10(2) (example 4), or the compound of chemical formula 12(2) (example 5) was used in substitution for the compound of chemical formula 8(2). In addition, the compound of chemical formula 8(10), the compound of chemical formula 9(2), the compound of chemical formula 10(2), and the compound of chemical formula 12(2) were all solid at the room temperature, and the current of the compound of chemical formula 8(10) or the like in the ion conductor was 1 mol/dm³.

### Comparative Example 1

The ion conductor was prepared in the same manner as example 1 except that the sulfuric acid was used in substitution for the compound of chemical formula 8(2). At that time, the content of the sulfuric acid in the ion conductor was 1 mol/dm³.

The conductivity of the ion conductors of these examples 1 to 5 and comparative example 1 was investigated, and the results shown in table 1 were obtained.

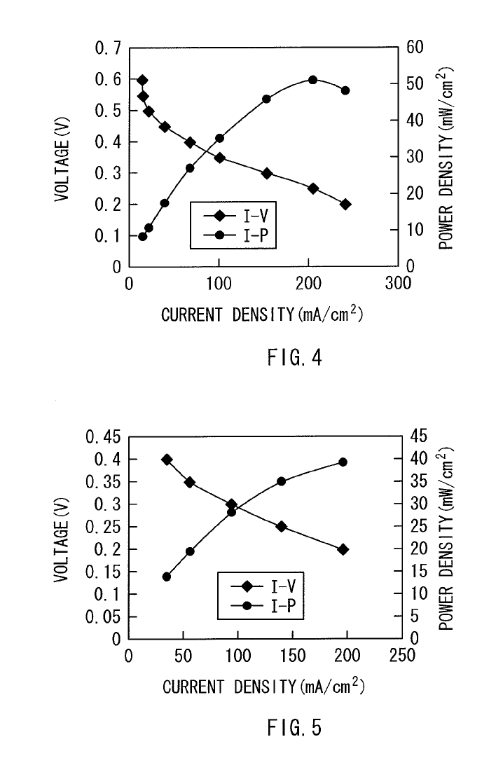

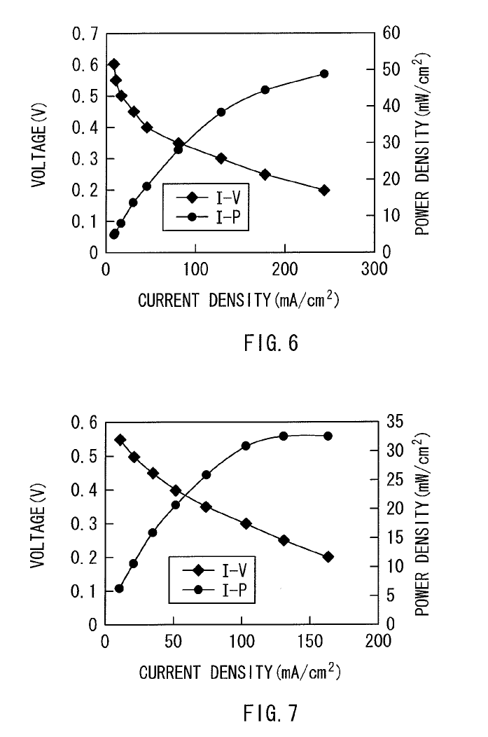

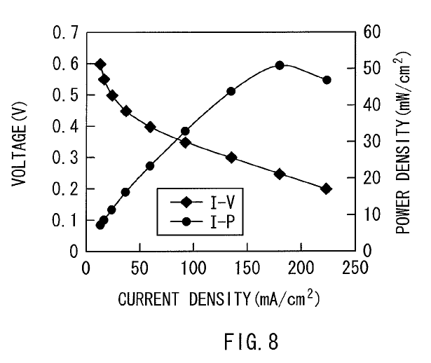

Also, the characteristics of the fuel cell system of these examples 1 to 5 were evaluated, and the results shown in FIGS. 4 to 8 were obtained. When these characteristics were evaluated, the characteristics evaluation was made by connecting each fuel cell system to a electrochemical measurement device (manufactured by Solartron, Multistat 1480), and 1-V (current-voltage) characteristics and I-P (current-power) characteristics were investigated by operation of a constant current (20 mA, 50 mA, 100 mA, 150 mA, 200 mA, and 250 mA) mode. In addition, FIG. 4 shows the result of example 1, FIG. 5 shows the result of example 2, FIG. 6 shows the result of example 3, FIG. 7 shows the result of example 4, and FIG. 8 shows the result of example 5, respectively.

TABLE 1

| | Ion conductor | | |
|---|---|---|---|
| | | Content | Conductivity |
| | Kind | (mol/dm³) | (Scm²) |
| Example 1 | Chemical formula 8(2) | 1 | 0.35 |
| Example 2 | Chemical formula 8(10) | | 0.11 |
| Example 3 | Chemical formula 9(2) | | 0.22 |
| Example 4 | Chemical formula 10(2) | | 0.10 |
| Example 5 | Chemical formula 12(2) | | 0.31 |
| Comparative | Sulfuric acid | 1 | 0.34 |
| example 1 | | | |

As shown in Table 1, in the ion conductors of examples 1 to 5 containing the compound of chemical formula 8(2), chemical formula 8(10), chemical formula 9(2), chemical formula 10(2), or chemical formula 12(2), although the conductivity was equal or less in comparison with the ion conductor of comparative example 1 containing the sulfuric acid, the conductivity was 0.1 S/cm² or more and the favorable conductivity was obtained. Also, since the conductivity was higher in examples 1 and 3 in comparison with examples 2 and 4, it was understood that the higher conductivity was obtained when the compound having the sulfonic acid group was used in comparison with the case where the compound having the phoshpponic acid group was used.

From this, in the ion conductor, it was confirmed that the favorable ion conductivity was obtained by containing the organic compound which was solid at the room temperature, and which had at least one of the sulfonic acid group and the phosphonic acid group.

Also, as illustrated in FIGS. 4 to 8, the characteristics of the fuel cell 110A of examples 1 to 5 were extremely favorable, and 51 mW/cm² (example 1), 39 mW/cm² (example 2), 48 mW/cm² (example 3), 32 mW/cm² (example 4), and 51 mW/cm² (example 5) were obtained as the power density. In addition, although not indicated in the examples, in the case where sulfuric acid of 1 mol/dm³ of comparative example 1 was used as the electrolyte fluid, the characteristics were substantially the same as those of the fuel cell 110A of examples 1 to 5.

From this, in the fuel cell 110A, it was confirmed that it was possible to suppress the resistance between the fuel electrode 10 and the oxygen electrode 20 low, since the ion conductor in which the organic compound which was solid at the room temperature and which had at least one of the sulfonic acid group and the phosphonic acid group was dissolved in the solvent was used as the electrolyte contained in the first fluid F1, and the electrolyte had the favorable ion conductivity. Thus, it was confirmed that the favorable characteristics such as the power density might be obtained.

In addition, in the examples, although the safety of the ion conductor was not indicated, it was obvious that the high safety was ensured in comparison with the ion conductor using the sulfuric acid as in comparative example 1, since the compounds of chemical formula 8(2), chemical formula 8(10), chemical formula 9(2), chemical formula 10(2), and chemical formula 12(2) used for preparing the ion conductors of examples 1 to 5 were solid at the room temperature. Thus, it was considered that the high safety was ensured also in the fuel cell using such an ion conductor. Also, although not indicated in the examples, an open-circuit voltage in the fuel cell systems of examples 1 to 5 was investigated, and the open-circuit voltage higher than that of the existing DMFC was obtained. That is, it was understood that the crossover was not generated, even when 100% methanol was used as the fluid F2 containing the fuel.

In the foregoing embodiments and the foregoing examples, although the case where the ion conductor as the first fluid F1 containing the electrolyte is existed in the flowing state all the time during the power generation has been described, the ion conductor of the embodiments are applicable to an electrolyte-stationary type fuel cell using a liquid as the electrolyte.

Also, for example, in the foregoing embodiments and the foregoing examples, although the specific description has been made on the configuration of the fuel cell 10, the oxygen electrode 20, the electrolyte path 30, and the fuel path 40, other configuration, or configuration by other material may be adopted. For example, the fuel path 40 may be composed of a porous sheet or the like in substitution for the sheet in which the path is formed by processing the resin sheet as described in the foregoing embodiments and the foregoing examples.

Further, for example, the material and the thickness of each component, the operation conditions of the fuel cell 110, and the like are not limited to those described in the foregoing embodiments and the foregoing examples, but other material and other thickness may be adopted, and other operation conditions of the fuel cell 110 may be adopted.

In addition, in the foregoing embodiments and the foregoing examples, although the fuel is supplied from the fuel supply section 150 to the fuel electrode 10, the fuel electrode 10 is the sealed type, and the fuel may be supplied according to needs.

Further, also, in the foregoing embodiments and the foregoing examples, although the air supply to the oxygen electrode 20 is performed by natural ventilation, the air may be forcibly supplied by using a pump or the like. In that case, the oxygen or the gas containing the oxygen may be supplied in substitution for the air.

Further, also, in the foregoing embodiments and the foregoing examples, although the description has been made on the unit-cell type fuel cell, the embodiments are applicable to a stacked type fuel cell in which a plurality of cells are stacked.

In addition, also, in the foregoing embodiments, although the case where the ion conductor is applied to the fuel cell has been described, the embodiments are applicable to other electrochemical devices such as a capacitor, a fuel sensor, or a display, in addition to the fuel cell.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-6. (canceled)

7. An ion conductor comprising:
an organic compound which is solid at a room temperature, and which has at least one of a sulfonic acid group (—SO₃H) and a phosphonic acid group (—PO₃H₂); and
a solvent for dissolving the organic compound.

8. An electrolytic solution for an electrochemical device comprising:
an organic compound which is solid at a room temperature, and which has at least one of a sulfonic acid group (—SO₃H) and a phosphonic acid group (—PO₃H₂); and
a solvent for dissolving the organic compound.

9. The ion conductor according to claim 7, wherein the organic compound is a compound represented by chemical formula 1:
R1-CₙR3₂ₙ-R2 [Chemical Formula 1]
wherein each R1 to R3 is a hydrogen group (—H), a hydroxy group (—OH), an amino group (—NH₂), an aminoalkyl group, a cyano group (—CN), a halogen group, a sulfonic acid group, or a phosphonic acid group; however, at least one of R1, R2, and R3 is the sulfonic acid group or the phosphonic acid group; n is an integer from 1 to 10 both inclusive.

10. The ion conductor according to claim 7, wherein the organic compound is at least one kind of compounds represented by chemical formula 2 and chemical formula 3: 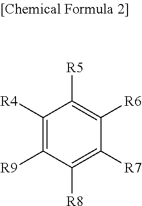
wherein each R4 to R9 is a hydrogen group, a hydroxy group, an amino group, an aminoalkyl group, a cyano group, a halogen group, an alkyl group, an alkoxy group, a sulfonic acid group, or a methylphosphonic acid group (—CH₂—PO₃); however, at least one of R4, R5, R6, R7, R8, and R9 is the sulfonic acid group or the methylphosphonic acid group; 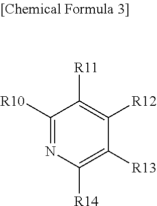
wherein each R10 to R14 is a hydrogen group, a hydroxy group, an amino group, an aminoalkyl group, a cyano group, a halogen group, an alkyl group, an alkoxy group, a sulfonic acid group, or a methylphosphonic acid group; however, at least one of R10, R11, R12, R13, and R14 is the sulfonic acid group or the methylphosphonic acid group.

11. The ion conductor according to claim 7, wherein the organic compound is at least one kind of compounds represented by chemical formula 4, chemical formula 5, and chemical formula 6: 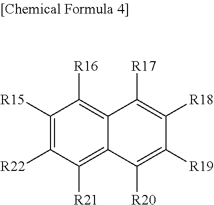
wherein each R15 to R22 is a hydrogen group, a hydroxy group, an amino group, an aminoalkyl group, a cyano group, a halogen group, an alkyl group, an alkoxy group, a sulfonic acid group, or a methylphosphonic acid group; however, at least one of R15, R16, R17, R18, R19, R20, R21, and R22 is the sulfonic acid group or the methylphosphonic acid group; 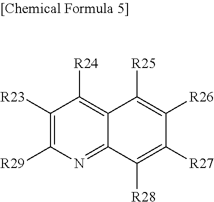
wherein each R23 to R29 is a hydrogen group, a hydroxy group, an amino group, an aminoalkyl group, a cyano group, a halogen group, an alkyl group, an alkoxy group, a sulfonic acid group, or a methylphosphonic acid group; however, at least one of R23, R24, R25, R26, R27, R28, and R29 is the sulfonic acid group or the methylphosphonic acid group; 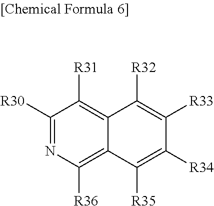
wherein each R30 to R36 is a hydrogen group, a hydroxy group, an amino group, an aminoalkyl group, a cyano group, a halogen group, an alkyl group, an alkoxy group, a sulfonic acid group, or a methylphosphonic acid group; however, at least one of R30, R31, R32, R33, R34, R35, and R36 is the sulfonic acid group or the methylphosphonic acid group.

12. A fuel cell in which a fuel electrode and an oxygen electrode are oppositely arranged with an electrolyte in between, wherein the electrolyte is composed of an ion conductor comprising:
an organic compound which is solid at a room temperature, and which has at least one of a sulfonic acid group and a phosphonic acid group; and
a solvent dissolving the organic compound.
